(19) United States
(12) Patent Application Publication
(10) Pub. No.: US 2026/0112706 A1
(43) Pub. Date: Apr. 23, 2026

(54) ELECTRODE ASSEMBLY AND METHOD OF MANUFACTURING THE ELECTRODE ASSEMBLY

(71) Applicant: SAMSUNG SDI CO., LTD., Yongin-si (KR)

(72) Inventors: Jihwan YOON, Yongin-si (KR); Jungwoo LEE, Yongin-si (KR); Misol KIM, Yongin-si (KR)

(21) Appl. No.: 19/176,352

(22) Filed: Apr. 11, 2025

(30) Foreign Application Priority Data
Oct. 18, 2024 (KR) 10-2024-0143001

(51) Int. Cl. H01M 10/0585; B23K 26/36; H01M 4/02; H01M 4/04; H01M 4/139; H01M 50/586; H01M 50/59

(52) U.S. Cl. CPC H01M 10/0585; B23K 26/36; H01M 4/04; H01M 4/139; H01M 50/586; H01M 50/59; H01M 2004/027; H01M 2004/028

(57) ABSTRACT

The present disclosure relates to an electrode assembly and a method of manufacturing the electrode assembly. The electrode assembly may include an electrode assembly including a positive electrode plate including a non-coated portion having a first side in a first direction and a first composite portion disposed adjacent to the non-coated portion in a first direction. The positive electrode plate may also include a positive electrode groove portion at a vertex where the first side and a second side meet. The electrode assembly may also include a negative electrode plate including a second composite portion covering a surface of the first composite portion and a negative electrode groove portion at a vertex where a third side and a fourth side of the negative electrode plate meet. A separator may be disposed between the positive electrode plate and the negative electrode plate.

### CROSS-REFERENCE TO RELATED APPLICATION

The present application claims priority to and the benefit of Korean Application No. 10-2024-0143001, filed on Oct. 18, 2024, in the Korean Intellectual Property Office, the entire disclosure of which is incorporated by reference herein.

### BACKGROUND

### Field

The present disclosure relates to an electrode assembly of a secondary battery and a method of manufacturing the electrode assembly.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The electrode assembly of a secondary battery has a structure in which electrode plates and separators are alternately laminated. An electrode plate may be made by forming an electrode tab using a notching process on an electrode plate that has been cut to a small width to fit the specifications of the battery cell. In general, the notching process may be performed by a method using a mold or a method using a laser. There may be problems associated with a notching process using a mold such as the mold wearing out or the generation of foreign substances when the mold is used repeatedly, which in turn may result in a deterioration in the quality of the electrode plate. Additionally, if the cell specifications change, the mold may need to be replaced. A notching process using a laser has a limitation in that it may not be used on parts containing materials such as iron (Fe).

The above information disclosed in this Background section is for enhancement of understanding of the background of the present disclosure. It may contain information that does not constitute related (or prior) art.

### SUMMARY

The present disclosure has been proposed to solve the above-described technical problems, and aspects of embodiments of the present disclosure are to provide an electrode assembly and a method of manufacturing the electrode assembly for solving the problems. But the present disclosure is not limited to solving the above-described technical problems.

These and other aspects and features of the present disclosure will be described in or will be apparent from the following description of embodiments of the present disclosure.

According to some aspects, an electrode assembly includes a positive electrode plate including a non-coated portion having a first side in a first direction and a second side in a second direction that is transverse to the first direction, a first composite portion adjacent to the non-coated portion, and a positive electrode groove portion formed at a vertex where the first side and the second side meet, a negative electrode plate including a second composite portion having a third side in the first direction and a fourth side in the second direction and covering a surface of the first composite portion, and a negative electrode groove portion formed at a vertex where the third side and the fourth side meet, and a separator positioned between the positive electrode plate and the negative electrode plate.

According to one embodiment, the positive electrode plate may include an insulating portion including an insulating layer that partially overlaps the first composite portion and covers at least a part of a surface of the non-coated portion, and a length of the insulating portion along the second direction may be 0.5 mm to about 10 mm.

According to one embodiment, the negative electrode groove portion may have a planar shape with a length in the second direction that decreases in a direction moving away from the third side.

According to one embodiment, a length of the negative electrode groove portion along the second direction may be 0.1 mm to 5 mm, and a length of the negative electrode groove portion along the first direction may be 0.1 mm to 5 mm.

According to one embodiment, the length of the negative electrode groove portion along the second direction may be 0.1 to 20 times the length of the negative electrode groove portion along the first direction.

According to one embodiment, a cut side surface of the negative electrode groove portion may include a curved portion.

According to one embodiment, at least a part of the curved portion of the negative electrode groove portion may have a curved shape that is convex downward or convex upward along the second direction.

According to one embodiment, the curved portion of the negative electrode groove portion may include an arc-shaped section.

According to one embodiment, the negative electrode plate may cover at least a part of the non-coated portion of the positive electrode plate.

According to one embodiment, a length of the second composite portion along the second direction may be greater than a length of the first composite portion along the second direction, and a length of the second composite portion along the first direction may be greater than a length of the first composite portion along the first direction.

According to one embodiment, an area of a plane of the second composite portion may be greater than an area of a plane of the first composite portion.

According to one embodiment, the positive electrode plate may further include a positive electrode tab portion extending from a surface of the non-coated portion, and the negative electrode plate may further include a negative electrode tab portion extending from a surface of the second composite portion.

According to one embodiment, a length of the positive electrode groove portion along the first direction may be 0.1 mm to 5 mm, and a length of the positive electrode groove portion along the second direction may be 0.1 mm to 5 mm.

According to one embodiment, a side surface of the positive electrode groove portion may include a curved portion, and the positive electrode groove portion may have a planar shape with a length in the first direction that decreases in a direction moving away from the first side.

According to some aspects, an electrode assembly includes a positive electrode plate including a non-coated portion, a first composite portion disposed adjacent to the non-coated portion along a transverse direction (TD), and a positive electrode groove portion formed at a vertex of the non-coated portion, a negative electrode plate including a second composite portion covering a surface of the first composite portion, and a negative electrode groove portion formed by cutting at least one vertex of the second composite portion, and a separator positioned between the positive electrode plate and the negative electrode plate. Here, at least one of a length of the positive electrode groove portion along the second direction and a length of the positive electrode groove portion along a first direction that is perpendicular to the second direction may be equal to or greater than a minimum detectable length for an inspection device that is configured to detect whether the positive electrode plate is defective, and at least one of a length of the negative electrode groove portion along the TD direction and a length of the negative electrode groove portion along the MD direction may be equal to or greater than the minimum detectable length for the inspection device, which is configured to detect whether the negative electrode plate is defective.

According to one embodiment, the positive electrode plate may include an insulating portion including an insulating layer that partially overlaps with the first composite portion and covers at least a part of a surface of the non-coated portion, and a length of the insulating portion along the second direction may be 0.5 mm to 10 mm.

According to one embodiment, a minimum detectable length for the inspection device may be 0.1 mm to 2 mm.

According to one embodiment, a length of the negative electrode groove along the first direction may be less than or equal to 50% of a difference between a length of the negative electrode plate and a length of the positive electrode plate in the first direction.

According to some aspects, a method of manufacturing an electrode assembly includes forming a positive electrode groove portion by cutting a part of a non-coated portion of a positive electrode plate that includes a first composite portion adjacent to a side surface of the non-coated portion along a second direction, forming a negative electrode groove portion by cutting a part of a second composite portion of a negative electrode plate that includes a second composite portion that covers a surface of the first composite portion, and positioning the positive electrode plate and the negative electrode plate such that the positive electrode groove portion and the negative electrode groove portion to correspond to two sides of a separator with the separator positioned between the positive electrode plate and the negative electrode plate. Here, at least one of a length of the positive electrode groove portion along a first direction that is perpendicular to the second direction and a length of the positive electrode groove portion along the second direction may be equal to or greater than a minimum detectable length of for inspection device that detects whether the positive electrode plate is defective, and at least one of a length of the negative electrode groove portion along the first direction and a length of the negative electrode groove portion along the second direction may be equal to or greater than a minimum detectable length for an inspection device that detects whether the negative electrode plate is defective.

According to one embodiment, the method may further include forming an insulating portion by disposing an insulating layer on the non-coated portion forming the positive electrode groove portion, wherein the forming of the positive electrode groove portion is performed by laser notching.

According to an exemplary embodiment, a positive electrode groove portion of a non-coated portion or an insulating portion configured to minimize defects due to N/P reversal is formed in a positive electrode plate of an electrode assembly such that the yield of the electrode assembly may be improved.

According to an exemplary embodiment, a negative electrode groove portion of a negative electrode plate of an electrode assembly is formed to be equal to or greater than the minimum detection limit for an inspection device that detects whether the negative electrode plate is defective such that inspection of the electrode assembly may be facilitated.

A method of manufacturing an electrode assembly according to an exemplary embodiment provides a method of forming a positive electrode groove portion in a non-coated portion or an insulating portion using a laser instead of a mold, which thereby reduces mold management and foreign matter problems.

However, aspects and features of the present disclosure are not limited to those described above, and other aspects and features not mentioned will be clearly understood by a person skilled in the art from the detailed description.

### BRIEF DESCRIPTION OF THE DRAWINGS

The drawings attached to this specification illustrate embodiments of the present disclosure and further describe aspects and features of the present disclosure together with the detailed description of the present disclosure. The present disclosure should not be construed as being limited to the drawings:

FIG. 1A is a plan view of an electrode assembly according to an exemplary embodiment.

FIG. 1B is a plan perspective view showing an enlarged area around one vertex of an electrode assembly according to the exemplary embodiment shown in FIG. 1A.

FIG. 1C is a plan view showing an enlarged view of an area around one vertex of a positive electrode plate included in an electrode assembly according to the exemplary embodiment shown in FIG. 1A.

FIG. 1D is a plan view showing an enlarged view of an area around one vertex of a negative electrode plate included in an electrode assembly according to the exemplary embodiment shown in FIG. 1A.

FIG. 1E is a perspective view showing an enlarged view of an area around one vertex of an electrode assembly according to the exemplary embodiment shown in FIG. 1a.

FIG. 2 is a plan view showing an enlarged view of an area around one vertex of an electrode assembly according to an exemplary embodiment.

FIG. 3 is a plan view showing an enlarged view of an area around one vertex of an electrode assembly according to an exemplary embodiment.

FIG. 4 is a plan view showing an enlarged view of an area around one vertex of an electrode assembly according to an exemplary embodiment.

FIG. 5 is a plan view showing an enlarged view of an area around one vertex of an electrode assembly according to an exemplary embodiment.

FIG. 6 is a plan view showing an enlarged view of an area around one vertex of a positive electrode plate included in an electrode assembly according to an exemplary embodiment.

FIG. 7 is an exploded perspective view of a secondary battery according to an exemplary embodiment.

FIG. 8 is a flowchart of a method of manufacturing an electrode assembly according to an exemplary embodiment.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted with meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the machine direction (MD) may correspond to the direction in which the electrode plate is moved through a transfer facility such as a transfer roller during electrode plate manufacturing. In the present disclosure, the MD direction may have the same meaning as the full-width direction of the electrode plate, but embodiments are not limited in this regard. The MD may also be referred to as the “first”direction herein. In the present disclosure, the transverse direction (TD) may correspond to a direction perpendicular to the MD direction on the plane of the electrode plate. In the present disclosure, the TD direction may the same meaning as the full-length direction of the electrode plate, but embodiments are not limited in this regard. The TD may also be referred to as the “second”direction herein.

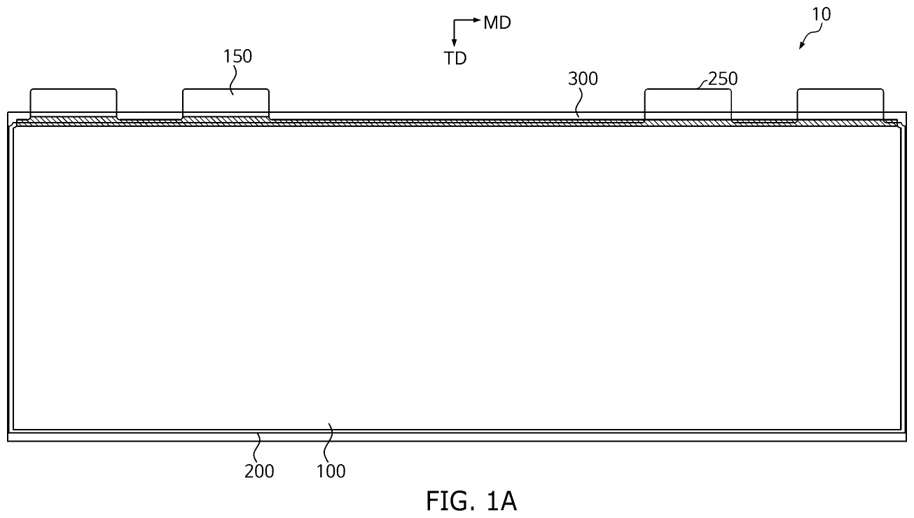

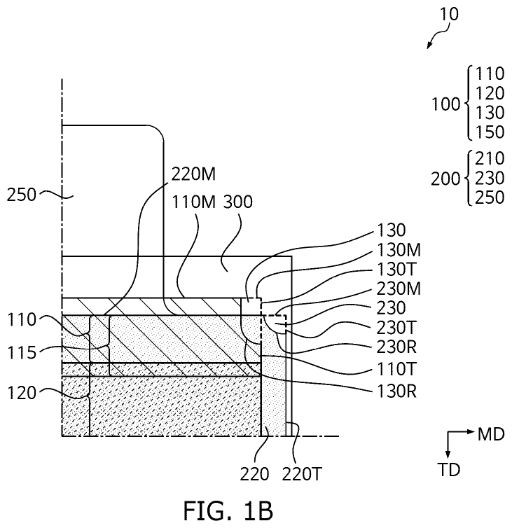

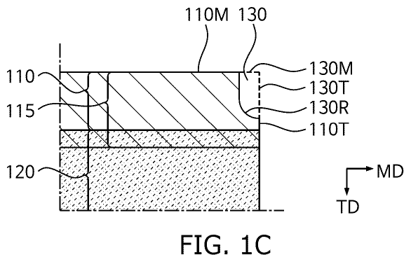

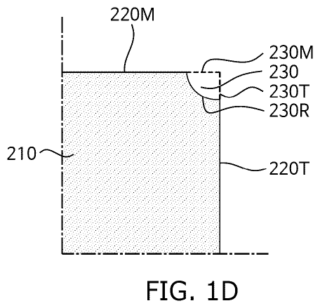

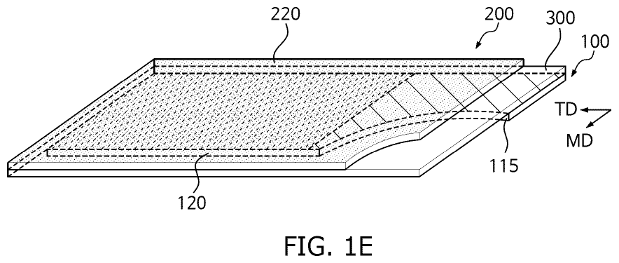

FIG. 1A is a plan view of an electrode assembly according to an exemplary embodiment. FIG. 1B is a plan perspective view showing an enlarged area around one vertex of an electrode assembly according to the exemplary embodiment of FIG. 1A. FIG. 1C is a plan view showing an enlarged view of an area around one vertex of a positive electrode plate included in an electrode assembly according to the exemplary embodiment of FIG. 1A. FIG. 1D is a plan view showing an enlarged view of an area around one vertex of a negative electrode plate included in an electrode assembly according to the exemplary embodiment of FIG. 1A. FIG. 1E is a perspective view showing an enlarged view of an area around one vertex of an electrode assembly according to the exemplary embodiment of FIG. 1A.

Referring to FIGS. 1A to 1E, an electrode assembly 10 according to an exemplary embodiment may include a positive electrode plate 100 including a non-coated portion 110 having a first side 110M in the MD direction and a second side 110T in the TD direction. The electrode assembly 10 further comprises a first composite portion 120 disposed along the TD direction from the non-coated portion 110, and a positive electrode groove portion 130 formed by cutting out at least a part of the non-coated portion 110 in a peripheral area of a vertex where the first side 110M and the second side 110T meet. The electrode assembly 10 also includes a negative electrode plate 200 including a second composite portion 220 having a third side 220M in the MD direction and a fourth side 220T in the TD direction and covering an exposed surface of the first composite portion 120. A negative electrode groove portion may be formed by cutting out at least a part of the second composite portion 220 in a peripheral area of a vertex where the third side 220M and the fourth side 220T meet. A separator 300 may be disposed between the positive electrode plate 100 and the negative electrode plate 200. Additionally, the positive electrode plate 100 may include an insulating portion 115 that partially overlaps with the first composite portion 120 and includes an insulating layer that covers at least a part of the exposed surface of the non-coated portion 110. The positive electrode groove portion 130 may be formed by cutting a part of the insulating portion 115. In particular, the positive electrode groove portion 130 may be formed by cutting together a part of the non-coated portion 110 and a part of the insulating layer covering the exposed surface of a part of the non-coated portion 110. The negative electrode groove portion 230 may be formed by cutting a part of the second composite portion 220.

According to an embodiment, at least one of the length of the positive electrode groove portion 130 along the TD direction or the length of the positive electrode groove portion 130 along the MD direction may be greater than or equal to the minimum detectable length of for inspection device that detects whether or not the positive electrode plate 100 is defective. In addition, at least one of the length of the negative electrode groove portion 230 along the TD direction or the length of the negative electrode groove portion 230 along the MD direction may be longer than the minimum detectable length of for inspection device that detects whether or not the negative electrode plate 200 is defective.

According to an embodiment, the length of the negative electrode groove portion 230 along the MD direction may be less than half of the difference between the length of the negative electrode plate 200 along the MD direction and the length of the positive electrode plate 100 along the MD direction. For example, the length of the side 230M in the MD direction of the negative electrode groove portion 230 may be less than half of the difference between the length of the negative electrode plate 200 in the MD direction and the length of the positive electrode plate 100 in the MD direction.

According to an embodiment, the non-coated portion 110 may be a part of the positive electrode plate 100 where no active material is disposed on the substrate. The first composite portion 120 may be a part in which an active material layer is disposed on a substrate in the positive electrode plate 100. The active material layer disposed in the first composite portion 120 may include a positive electrode active material. The active material layer disposed in the first composite portion 120 may be coated on the substrate forming the positive electrode plate 100. The substrate of the positive electrode plate 100 may be composed of, for example, aluminum foil, and the active material layer disposed on the substrate may include, for example, a transition metal oxide.

According to an embodiment, the insulating portion 115 may be a portion of the positive electrode plate 100 in which an insulating layer is disposed on the substrate. Alternatively, the insulating portion 115 may be a portion in which an insulating layer is disposed on the non-coated portion 110 in the positive electrode plate 100. The non-coated portion 110 and the insulating portion 115 may partially overlap. The insulating portion 115 may cover at least a part of the exposed surface of the non-coated portion 110. For example, the surface of the remaining portion of the non-coated portion 110 excluding the portion where the positive electrode tab portion 150 is formed may be covered. The insulating portion 115 may include an insulating material such as at least one of a ceramic or a polymide (PI) material. But embodiments of the present disclosure are not limited to these examples and may include various other insulating materials. The insulating portion 115 may be disposed in contact with the first composite portion 120. In the plan view, the insulating portion 115 may be disposed in contact with one side surface of the first composite portion 120. The insulating portion 115 may be disposed to partially overlap with the first composite portion 120. In the area where the insulating portion 115 and the first composite portion 120 overlap, the insulating layer of the insulating portion 115 may be disposed above the active material layer of the first composite portion 120. That is, the insulating portion 115 may cover a portion of the first composite portion 120, and the insulating portion 115 and the composite portion 120 may partially overlap. In a specific example, the length of the insulating portion 115 along the TD direction may be about 0.5 mm to about 10 mm. The length of the insulating portion 115 along the TD direction may be selected by considering the length of the non-coated portion 110 along the TD direction, the length of the first composite portion 120 along the TD direction, or the length of the second composite portion 220 along the TD direction. For example, the length of the insulating portion 115 along the MD direction may be substantially the same as the length of the non-coated portion 110 along the MD direction.

Because the electrode assembly 10 according to the exemplary embodiment includes an insulating portion 115, short circuiting between the positive electrode plate 100 and the negative electrode plate 200 may be reduced.

According to an embodiment, the positive electrode groove portion 130 may be formed in at least one of the vertices of the non-coated portion 110. For example, if a non-coated portion 110 is disposed on one side of the positive electrode plate 100, a part of the non-coated portion 110 may be cut off at the vertex where the first side 110M and the second side 110T meet to thereby form the positive electrode groove portion 130. Additionally, a part of the non-coated portion 110 may be cut off at the vertex where the first side 110M meets a side opposite to the second side 110T, thereby forming the positive electrode groove portion 130. In the case where the positive electrode plate 100 includes an insulating portion 115, the positive electrode groove portion 130 may be formed by cutting the insulating portion 115.

The positive electrode groove portion 130 may include the cut side surface of the non-coated portion 110 as part of its outer perimeter. In an embodiment, the cut side surface of the positive electrode groove portion 130 may be straight. In this case, the planar shape of the positive electrode groove portion 130 may be a right triangle shape. In another embodiment, the cut side surface of the positive electrode groove portion 130 may include a curved portion 130R. The curved shape of the curved portion 130R may be selected as needed. The remaining perimeter of the positive electrode groove portion 130 may include a side 130M in the MD direction and a side 130T in the TD direction of the positive electrode groove portion 130. However, embodiments of the present disclosure are not limited to these examples, and the cut side surface of the positive electrode groove portion 130 may include both a straight portion and a curved portion.

According to an embodiment, the positive electrode groove portion 130 may have various planar shapes. Because the positive electrode groove portion 130 may be formed by cutting off the vertex of the non-coated portion 110, the positive electrode groove portion 130 may include the side in the MD direction 130M and the side in the TD direction 130T of the positive electrode groove portion 130 as part of its perimeter in the plan view. Because the MD direction and the TD direction are perpendicular to each other, the side in the MD direction 130M and the side in the TD direction 130T may be perpendicular to each other. In the example depicted in FIG. 1C, the planar shape of the positive electrode groove portion 130 is replaced with a curved portion 130R that is a diagonal variation curve of a right triangle. The planar shape of the positive electrode groove portion 130 may have various shapes depending on the shape of the curved portion 130R. For example, the positive electrode groove portion 130 may have a shape such as a circular sector, an area including an arc within a circle, an area including an arc within an ellipse, etc. As another example, the planar shape of the positive electrode groove portion 130 may be a quadrant of a circular sector. However, the planar shape of the positive electrode groove portion 130 is not limited to these curved examples, and may be a right triangle whose the diagonal side is not replaced by a curved line, or may have a planar shape in which the diagonal side is replaced to include a straight section and a curved section.

According to an embodiment, the planar shape of the positive electrode groove portion 130 may be such that the length of the positive electrode groove portion 130 in the MD direction decreases in a direction moving away from the first side 110M. In other words, the length of the planar shape of the positive electrode groove portion 130 in the MD direction may be reduced along the TD direction away from the first side 110M. The length of the MD direction side 130M and the length of the TD direction side 130T of the planar shape of the positive electrode groove portion 130 may correspond to the MD direction long axis length and the TD direction long axis length of the planar shape of the positive electrode groove portion 130, respectively. For example, the planar shape of the positive electrode groove portion 130 may be disposed inside a rectangle including an MD direction side 130M and a TD direction side 130T. As another example, if the shape of the positive electrode groove portion 130 is a right triangle, the length of this shape in the MD direction may decrease in a direction moving away from the first side 110M. According to another embodiment, the positive electrode groove portion 130 may have a planar shape in which the length in the MD direction decreases in a direction moving away from the first side 110M, but the length in the MD direction remains constant for a part of the length in the direction moving away from the first side 110M.

According to an embodiment, at least a part of the curved portion 130R of the positive electrode groove portion 130 may have a curved shape that is convex upward or convex downward along the TD direction. For example, the curved portion 130R may have a curved shape that is convex upward overall, or the curved portion 130R may have a curved shape that is convex downward overall. The curved portion 130R may be an arc of a circle, and the center of the circle may be correspond to a position as needed. Alternatively, the curved portion 130R may include both an upwardly convex portion and a downwardly convex portion. In such a case, there is an inflection point located between the upwardly convex portion and the downwardly convex portion. As the positive electrode groove portion 130 moves away from the first side 110M, a curved shape in which the curved portion 130R is convex upward or convex downward may be selected so that the length along the MD direction decreases.

According to a particular embodiment, the length of the positive electrode groove portion 130 along the MD direction may be from about 0.05 mm to about 10 mm. For example, the length of the MD direction side 130M of the positive electrode groove portion 130 may be from about 0.05 mm to about 10 mm. The length of the MD direction side 130M of the positive electrode groove portion 130 may be selected based on the size of the positive electrode plate 100, the size of the negative electrode plate 200, or the size of the negative electrode groove portion 230. The length of the MD direction side 130M of the positive electrode groove portion 130 may be selected so that the second composite portion 220 of the negative electrode plate 200 may cover the first composite portion 120 of the positive electrode plate 100. However, embodiments of the present disclosure are not limited to these examples, and may be selected for various purposes such as improving the yield of plate manufacturing, reducing cell defects, or increasing cell capacity. For example, the MD direction side 130M of the positive electrode groove portion 130 may have a length of about 0.1 mm to about 5 mm. When the length along the MD direction decreases as the planar shape of the positive electrode groove portion 130 moves away from the first side 110M, the side 130M in the MD direction of the positive electrode groove portion 130 may be the long axis of the positive electrode groove portion 130 in the MD direction.

The length of the positive electrode groove portion 130 along the TD direction may be from about 0.05 mm to about 10 mm. For example, the length of the side 130T in the TD direction of the positive electrode groove portion 130 may be from about 0.05 mm to about 10 mm. The length of the side 130T in the TD direction of the positive electrode groove portion 130 may be based on the size of the positive electrode plate 100, the size of the negative electrode plate 200, or the size of the negative electrode groove portion 230. Additionally, the length of the side 130T in the TD direction of the positive electrode groove portion 130 may be based on the length of the side 130M in the MD direction of the positive electrode groove portion 130. For example, the length of the side 130T in the TD direction of the positive electrode groove portion 130 may be about 0.1 to about 20 times the length of the side 130M in the MD direction of the positive electrode groove portion 130. The length of the side 130T in the TD direction of the positive electrode groove portion 130 may be selected so that the second composite portion 220 of the negative electrode plate 200 may cover the first composite portion 120 of the positive electrode plate 100. However, embodiments of the present disclosure are not limited to these examples, and may be selected as needed for various purposes such as improving the yield of plate manufacturing, reducing cell defects, or increasing cell capacity. For example, the side 130T in the TD direction of the positive electrode groove portion 130 may have a length of about 0.1 mm to about 5 mm. When the length along the MD direction decreases as the planar shape of the positive electrode groove portion 130 moves away from the first side 110M, the side 130T in the TD direction of the positive electrode groove portion 130 may be the long axis of the positive electrode groove portion 130 in the TD direction.

According to an embodiment, at least one of the length of the positive electrode groove portion 130 along the MD direction or the length of the positive electrode groove portion 130 along the TD direction may be greater than or equal to the minimum detectable length for an inspection device that detects whether or not the positive electrode plate 100 is defective. The inspection device may be disposed around the moving positive electrode plate 100 while or after the positive electrode plate 100 is notched to thereby perform an inspection to detect defects in the positive electrode plate 100. Alternatively, the inspection device may be disposed around the positive electrode plate 100 before or after laminating the positive electrode plate 100, or during laminating the positive electrode plate 100, to thereby perform an inspection to detect defects in the positive electrode plate 100. In an example, an inspection device that detects whether a positive electrode plate 100 is defective may be a vision inspection device, and the minimum detectable length of the inspection device may vary depending on the specifications of the inspection device. For example, the minimum detectable length of the inspection device may be in the range of about 0.1 mm to 2 mm. According to one example, the inspection device may detect a defect by inspecting the positive electrode plate 100 when the length of the positive electrode plate 100 in one direction is 2 mm or more. According to another example, the inspection device may detect a defect by inspecting the positive electrode plate 100 when the length of the positive electrode plate 100 along each of two perpendicular directions (i.e., the MD direction and the TD direction) is 1 mm or more. However, embodiments of the present disclosure are not limited to these examples, and the minimum detectable length of the inspection device may be less than or greater than these ranges.

According to an exemplary embodiment, the electrode assembly 10 includes a positive electrode groove portion 130 formed by cutting at least a part of the non-coated portion 110 and/or at least a part of the insulating portion 115, so the positive electrode groove portion 130 may be formed by notching using a laser in addition to notching using a mold. Forming notches in the positive electrode groove portion 130 using a laser may be advantageous as it requires little or no mold management and foreign matter problems may be prevented.

The positive electrode plate 100 of the electrode assembly 10 according to the exemplary embodiment may further include a positive electrode tab portion 150. The positive electrode tab portion 150 may be a region where an active material layer is not disposed on the substrate. For example, the positive electrode tab portion 150 may be formed by cutting the non-coated portion 110. The positive electrode tab portion 150 may be in contact with the non-coated portion 110. Alternatively, the positive electrode tab portion 150 may be in contact with the insulating portion 115. The positive electrode plate 100 may include at least one positive electrode tab portion 150. In another example, the positive electrode plate 100 may include two positive electrode tab portions 150, with the two positive electrode tab portions 150 spaced apart from each other. The positive electrode tab portion 150 may provide a portion where the positive electrode tab is electrically connected.

As discussed above, the electrode assembly 10 according to an exemplary embodiment may include the negative electrode plate 200. The negative electrode plate 200 may include the second composite portion 220 and the negative electrode groove portion 230. Additionally, the negative electrode plate 200 may include a negative electrode tab portion 250, and the negative electrode tab portion 250 may be formed on one side surface of the second composite portion 220.

According to an embodiment, the second composite portion 220 may be a portion of the negative electrode plate 200 where an active material layer is disposed on a substrate. A portion of the negative electrode plate 200 where the active material layer is not disposed on the substrate may correspond to a non-coated portion, and a negative electrode tab portion 250 may be formed in the non-coated portion of the negative electrode plate 200. The active material layer disposed in the second composite portion 220 may include a negative active material. Additionally, the active material layer disposed in the second composite portion 220 may be coated on the substrate from which the negative electrode plate 200 is formed. The substrate of the negative electrode plate 200 may be composed of, for example, aluminum foil, and the active material layer disposed on the substrate may include, for example, a transition metal oxide.

The second composite portion 220 may cover the upper portion of the first composite portion 120. In this regard, the term “cover” may mean that the second composite portion 220 is disposed on the first composite portion 120 so that the first composite portion 120 is substantially covered in a plan view. By covering the first composite portion 120 with the second composite portion 220, the second composite portion 220 may cover the exposed surface of the first composite portion 120. In order for the second composite portion 220 to cover the first composite portion 120, the length of the second composite portion 220 along the TD direction may be greater than the length of the first composite portion 120 along the TD direction. The length of the second composite portion 220 along the TD direction may be less than or equal to the sum of the length of the first composite portion 120 along the TD direction and the length of the non-coated portion 110. But embodiments of the present disclosure are not limited to these example configurations. For example, the negative electrode plate 200 may cover at least a part of the non-coated portion 110. That is, one side surface of the negative electrode plate 200 may be disposed on the non-coated portion 110. Additionally, in order for the second composite portion 220 to cover the first composite portion 120, the length of the second composite portion 220 along the MD direction may be greater than the length of the first composite portion 120 along the MD direction. And the area of the planar shape of the second composite portion 220 may be greater than the area of the planar shape of the first composite portion 120.

If the second composite portion 220 covers the first composite portion 120, the negative electrode groove portion 230 may be formed by cutting at least a part of the second composite portion 220 that is not disposed on the first composite portion 120. According to the disposition of the first composite portion 120 and the second composite portion 220 as described above and the disposition of the formed negative electrode groove portion 230, the defect of the electrode assembly due to N/P (negative to positive active material ratio) reversal may be reduced.

According to an embodiment, the negative electrode groove portion 230 may be formed in at least one of the vertices of the second composite portion 220. For example, the negative electrode groove portion 230 may be formed by cutting the second composite portion 220 at the vertex where the third side 220M and the fourth side 220T meet. Additionally, a second composite portion 220 may be cut at the vertex where the sides located on opposite sides of the third side 220M and the fourth side 220T meet to form a negative electrode groove portion 230.

The negative electrode groove portion 230 may include the cut side surface of the second composite portion 220 as part of its perimeter. In an embodiment, the cut side surface of the negative electrode groove portion 230 may be straight. In this case, the planar shape of the negative electrode groove portion 230 may be a right triangle shape. In another embodiment, the cut side surface of the negative electrode groove portion 230 may include a curved portion 230R. The curved shape of the curved portion 230R may be selected as needed. he remaining circumference of the negative electrode groove portion 230 may include a side 230M in the MD direction and a side 230T in the TD direction of the negative electrode groove portion 230. However, embodiments of the present disclosure are not limited to these examples, and the cut side surface of the negative electrode groove portion 230 may include both a straight portion and a curved portion.

According to an embodiment, the negative electrode groove portion 230 may have various planar shapes. Because the negative electrode groove portion 230 may be formed by cutting off the vertex portion of the second composite portion 220, the negative electrode groove portion 230 may include the MD direction side 230M and the TD direction side 230T of the negative electrode groove portion 230 as part of its perimeter in a plan view. Because the MD direction and the TD direction are perpendicular to each other, the MD direction side 230M and the TD direction side 230T of the negative electrode groove portion 230 may be perpendicular to each other. For example, the planar shape of the negative electrode groove portion 230 may be replaced with a curved portion 230R that is a diagonal variation curve of a right triangle. The planar shape of the negative electrode groove portion 230 may have various shapes depending on the shape of the curved portion 230R. For example, the negative electrode groove portion 230 may have a shape such as a circular sector, an area including an arc within a circle, an area including an arc within an ellipse, etc. As another example, the planar shape of the negative electrode groove portion 230 may be a quadrant of a circular sector. However, the embodiment is not limited to these curved examples, and the planar shape of the negative electrode groove portion 230 may be a right triangle that is not replaced with a diagonal variation curve, or may have a planar shape that is replaced to include a diagonal variation straight section and curve section.

According to an embodiment, the planar shape of the negative electrode groove portion 230 may be such that the length along the MD direction of the negative electrode groove portion 230 decreases in a direction moving away from the third side 220M. In other words, the length of the MD direction of the planar shape of the negative electrode groove portion 230 may be reduced along the TD direction away from the third side 220M. The length of the MD direction side 230M and the length of the TD direction side 230T of the planar shape of the negative electrode groove portion 230 may correspond to the MD direction long axis length and the TD direction long axis length of the planar shape of the negative electrode groove portion 230, respectively. In other words, the planar shape of the negative electrode groove portion 230 may be disposed inside a rectangle including an MD direction side 230M and a TD direction side 230T. As another example, if the shape of the negative electrode groove portion 230 is a right triangle, the length of this shape in the MD direction may decrease in a direction moving away from the third side 220M. According to another embodiment, the negative electrode groove portion 230 may have a planar shape in which the length in the MD direction decreases in a direction moving away from the third side 220M, but the length in the MD direction is constant for a part of the length in the direction moving away from the third side 220M.

According to an embodiment, at least a part of the curved portion 230R of the negative electrode groove portion 230 may have a curved shape that is convex upward or convex downward along the TD direction. For example, the curved portion 230R may have a curved shape that is convex upward overall, or the curved portion 230R may have a curved shape that is convex downward overall. The curved portion 230R may be an arc of a circle, and the center of the circle may correspond to a position as needed. Alternatively, the curved portion 230R may include both an upwardly convex portion and a downwardly convex portion. In such a case, there is an inflection point located between the upwardly convex portion and the downwardly convex portion. As the negative electrode groove portion 230 moves away from the third side 220M, a curved shape in which the curved portion 230R is convex upward or convex downward may be selected so that the length along the MD direction decreases.

According to a particular embodiment, the length of the negative electrode groove portion 230 along the MD direction may have a length of about 0.05 mm to about 10 mm. For example, the length of the MD direction side 230M of the negative electrode groove portion 230 may be from about 0.05 mm to about 10 mm. The length of the MD direction side 230M of the negative electrode groove portion 230 may be selected in based on the size of the positive electrode plate 100, the size of the positive electrode plate 200, or the size of the positive electrode groove portion 130. The length of the MD direction side 230M of the negative electrode groove portion 230 may be selected so that the second composite portion 220 of the negative electrode plate 200 may cover the first composite portion 120 of the positive electrode plate 100. However, embodiments of the present disclosure are not limited to these examples, and may be selected for various purposes such as improving the yield of plate manufacturing, reducing cell defects, or increasing cell capacity. For example, the MD direction side 230M of the negative electrode groove portion 230 may have a length of about 0.1 mm to about 5 mm. When the length along the MD direction decreases as the planar shape of the negative electrode groove portion 230 moves away from the third side 220M, the side 230M in the MD direction of the negative electrode groove portion 230 may be the long axis of the negative electrode groove portion 230 in the MD direction.

The length of the negative electrode groove portion 230 along the TD direction may be from about 0.05 mm to about 10 mm. For example, the length of the side 230T in the TD direction of the negative electrode groove portion 230 may be from about 0.05 mm to about 10 mm. The length of the side 230T in the TD direction of the negative electrode groove portion 230 may be based on the size of the positive electrode plate 100, the size of the positive electrode plate 200, or the size of the negative electrode groove portion 230. Additionally, the length of the side 230T in the TD direction of the negative electrode groove portion 230 may be based on the length of the side 230M in the MD direction of the negative electrode groove portion 230. For example, the length of the side 230T in the TD direction of the negative electrode groove portion 230 may be about 0.1 to about 20 times the length of the side 230M in the MD direction of the negative electrode groove portion 230. The length of the side 230T in the TD direction of the negative electrode groove portion 230 may be selected so that the second composite portion 220 of the negative electrode plate 200 may cover the first composite portion 120 of the positive electrode plate 100. However, embodiments of the present disclosure are not limited to these examples, and may be selected as needed for various purposes such as improving the yield of plate manufacturing, reducing cell defects, or increasing cell capacity. For example, the side 230T in the TD direction of the negative electrode groove portion 230 may have a length of about 0.1 mm to about 5 mm. When the length along the MD direction decreases as the planar shape of the negative electrode groove portion 230 moves away from the third side 220M, the side 230T in the TD direction of the negative electrode groove portion 230 may be the long axis of the negative electrode groove portion 230 in the TD direction.

According to an embodiment, at least one of the length of the negative electrode groove portion 230 along the MD direction or the length of the negative electrode groove portion 230 along the TD direction may be greater than or equal to the minimum detectable length for an inspection device that detects whether or not the negative electrode plate 200 is defective. The inspection device may be disposed around the moving negative electrode plate 200 while or after the negative electrode plate 200 is notched to thereby perform an inspection to detect defects in the negative electrode plate 200. Alternatively, the inspection device may be disposed around the negative electrode plate 200 before or after laminating the negative electrode plate 200, or during laminating the negative electrode plate 200, to thereby perform an inspection to detect defects in the negative electrode plate 200. In an example, an inspection device that detects whether a positive electrode plate 200 is defective may be a vision inspection device, and the minimum detectable length of the inspection device may vary depending on the specifications of the inspection device. For example, the minimum detectable length of the inspection device may be in the range of about 0.1 mm to 2 mm. According to one example, the inspection device may detect a defect by inspecting the negative electrode plate 200 when the length of the negative electrode plate 200 in one direction is 2 mm or more. According to another example, the inspection device may detect a defect by inspecting the negative electrode plate 200 when the length of the negative electrode plate 200 in each of two perpendicular directions (i.e., the MD direction and the TD direction) is 1 mm or more. However, embodiments of the present disclosure are not limited to these examples, and the minimum detectable length of the inspection device may be less than or greater than these ranges.

According to an embodiment, the length of the negative electrode groove portion 230 along the MD direction may be less than half of the difference between the length of the negative electrode plate 200 and the length of the positive electrode plate 100 along the MD direction. In such a case, even if the negative electrode groove portion 230 is formed, the length of the negative electrode plate 200 along the MD direction may be greater than the length of the positive electrode plate 100 along the MD direction.

The negative electrode groove portion 230 may be formed so as not to be located on the first composite portion 120. On a plan view, the negative electrode groove portion 230 may not overlap with the first composite portion 120. Accordingly, all areas of the first composite portion 120 in the plan view may be overlapped by the second composite portion 220.

The negative electrode plate 200 of the electrode assembly 10 according to the exemplary embodiment may further include a negative electrode tab portion 250. The negative electrode tab portion 250 may be a region where an active material layer is not disposed on the substrate. For example, the negative electrode tab portion 250 may be formed by cutting the second composite portion 220 of the negative electrode plate 200. The negative electrode tab portion 250 may be disposed in contact with the second composite portion 220. The negative electrode plate 200 may include at least one negative electrode tab portion 250. The negative electrode tab portion 250 may provide a portion where the negative tab is electrically connected.

The electrode assembly 10 according to an exemplary embodiment may include the separator 300 disposed between a positive electrode plate 100 and a negative electrode plate 200. The separator 300 may electrically insulate the positive electrode plate 100 and the negative electrode plate 200 while allowing the movement of specific ions between the plates 100 and 200. That is, the separator 300 may have the function of preventing a short circuit between the positive electrode plate 100 and the negative electrode plate 200. The separator 300 may include, but is not limited to, a polyethylene film, a polypropylene film, a polyethylene-polypropylene film, etc. The length of the separator 300 along the MD direction may be greater than the length of the negative electrode plate 200 along the MD direction, and the length of the separator 300 along the TD direction may be greater than the length of the negative electrode plate 200 along the TD direction.

According to an exemplary embodiment, the positive electrode groove portion 130 of the electrode assembly 10 may have a size in which at least one of the length of the positive electrode groove portion 130 along the MD direction and the length of the positive electrode groove portion 130 along the TD direction is greater than the minimum detectable length for the inspection device. In addition, the negative electrode groove portion 230 of the electrode assembly 10 according to the exemplary embodiment may have a size in which at least one of the length of the negative electrode groove portion 230 along the MD direction and the length of the negative electrode groove portion 230 along the TD direction is greater than the minimum detectable length for the inspection device, and, at the same time, the second composite portion 220 covers the exposed surface of the first composite portion 120 and prevents the negative electrode groove portion 230 from being disposed on the first composite portion 120. Accordingly, the yield of the electrode assembly 10 may be increased because the defects due to N/P reversal may be reduced, and inspection of the electrode assembly 10 may be facilitated. In addition, by performing notching using a laser to cut the non-coated portion 110 or the insulating portion 115 of the positive electrode plate 100, mold management problems and foreign matter problems may be reduced or eliminated.

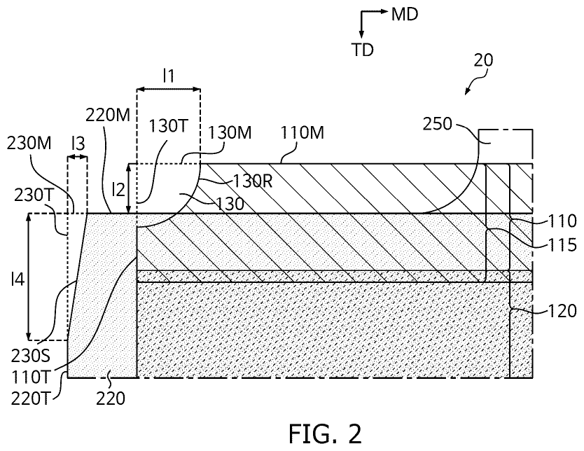

FIG. 2 is a plan view of an enlarged view of an area around one vertex of an electrode assembly according to an exemplary embodiment. In FIG. 2 the separator 300 is omitted, but the separator 300 may be disposed between a positive electrode plate 100 and a negative electrode plate 200.

Referring to FIG. 2, the positive electrode plate 100 of the electrode assembly 20 according to an exemplary embodiment may include a non-coated portion 110, a first composite portion 120, and a positive electrode groove portion 130. An insulating layer may be disposed on the non-coated portion 110 to form an insulating portion 115. The insulating portion 115 and the first composite portion 120 may partially overlap. At least a part of the insulating portion 115 may be cut to form a positive electrode groove portion 130, and the perimeter of the positive electrode groove portion 130 may include a side 130M in the MD direction, a side 130T in the TD direction, and a curved portion 130R. The length l1 of the side 130M in the MD direction of the positive electrode groove portion 130 may be substantially equal to the length l2 of the side 130T in the TD direction of the positive electrode groove portion 130. The curved portion 130R may be an arc of a circle, and the planar shape of the positive electrode groove portion 130 may be a quadrant. In a specific example, the side 130M in the MD direction of the positive electrode groove portion 130 may have a length of about 1.0 mm, and the side 130T in the TD direction of the positive electrode groove portion 130 may have a length of about 1.0 mm. The length of the positive electrode groove portion 130 in the MD direction may decrease in a direction moving away from the first side 110M. However, embodiments of the present disclosure are not limited to these examples, and the positive electrode groove portion 130 may include a straight portion instead of a curved portion 130R.

The negative electrode plate 200 of the electrode assembly 20 according to an exemplary embodiment may include a second composite portion 220, and a negative electrode groove portion 230 formed by cutting at least a part of the second composite portion 220. The cut side surface of the negative electrode groove portion 230 may include a straight portion 230S. The perimeter of the negative electrode groove portion 230 may include a side 230M in the MD direction, a side 230T in the TD direction, and a straight portion 230S. The length l4 of the side 230T in the TD direction of the negative electrode groove portion 230 may be greater than the length l3 of the side 230M in the MD direction of the negative electrode groove portion 230. In a particular example, the side 230T in the TD direction of the negative electrode groove portion 230 may have a length of about 2.0 mm, and the side 230M in the MD direction may have a length of about 0.3 mm. The length l4 of the side 230T in the TD direction of the negative electrode groove portion 230 may be about 6 to 7 times the length l3 of the side 230M in the MD direction of the negative electrode groove portion 230. The length of the negative electrode groove portion 230 in the MD direction may decrease in a direction moving away from the third side 220M.

In an electrode assembly 20 according to an exemplary embodiment, the second composite portion 220 of the negative electrode plate 200 may cover the exposed surface of the first composite portion 120 of the positive electrode plate 100. The MD direction side 230M of the negative electrode groove portion 230 may be less than half of the difference between the length of the negative electrode plate 200 and the length of the positive electrode plate 100 along the MD direction. However, embodiments of the present disclosure are not limited to this example, and if the second composite portion 220 covers the first composite portion 120, the MD direction side 230M of the negative electrode groove portion 230 may be equal to or greater than half of the difference between the length of the negative electrode plate 200 and the length of the positive electrode plate 100 along the MD direction.

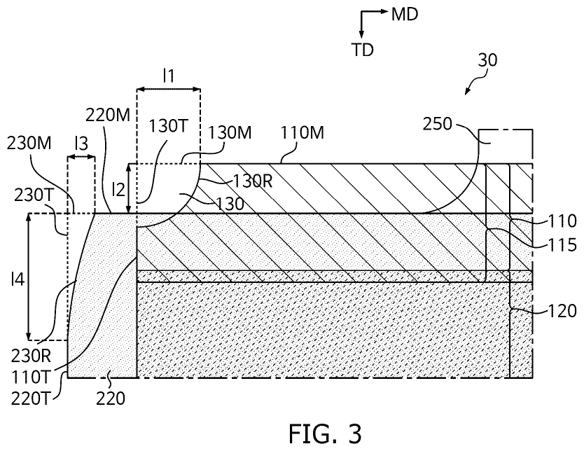

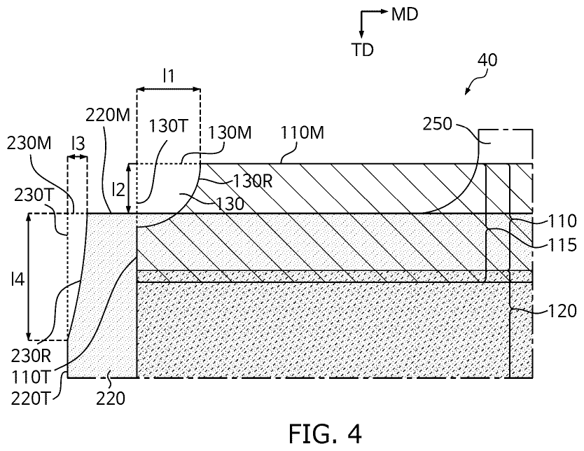

At least one of the length of the positive electrode groove portion 130 along the MD direction and the length of the positive electrode groove portion 130 along the TD direction may be longer than the minimum detectable length for an inspection device that detects whether the positive electrode plate 100 is defective. Further, at least one of the length of the negative electrode groove portion 230 along the MD direction and the length of the negative electrode groove portion 230 along the TD direction may be equal to or greater than the minimum detectable length of for inspection device that detects whether or not the negative electrode plate 200 is defective. The inspection device for detecting whether the positive electrode plate 100 is defective may be the same as or different from the inspection device for detecting whether the negative electrode plate 200 is defective. In particular examples, in order for the inspection device(s) to be detect the plates 100 and 200, the groove portion(s) may have a size of at least 1.0 mm in length along the MD direction and at least 1.0 mm in length along the TD direction. Alternatively, the length along the MD direction of the groove portion(s) and the length along the TD direction of the groove portion(s) may have a size of 2.0 mm or more. The length of the side 130M in the MD direction and the length of the side 130T in the TD direction of the positive electrode groove portion 130 are each about 1.0 mm, which may be detected by an inspection device. Among the MD direction side 230M and the TD direction side 230T of the negative electrode groove portion 230, the length of the TD direction side 230T is about 2.0 mm, which may be detected by an inspection device. FIG. 3 is a plan view showing an enlarged view of an area around one vertex of an electrode assembly according to an exemplary embodiment. FIG. 4 is a plan view showing an enlarged view of an area around one vertex of an electrode assembly according to another exemplary embodiment.

In FIGS. 3 and 4, an illustration of the separator 300 in the electrode assembly 30 and 40 is not illustrated, but the separator 300 may be disposed between the positive electrode plate 100 and the negative electrode plate 200.

Referring to FIGS. 3 and 4, the positive electrode plate 100 of the electrode assembly 30 or 40 according to an exemplary embodiment may include a non-coated portion 110, a first composite portion 120, and a positive electrode groove portion 130. An insulating layer may be disposed on the non-coated portion 110 to form an insulating portion 115. The insulating portion 115 and the first composite portion 120 may partially overlap. At least a part of the insulating portion 115 may be cut to form a positive electrode groove portion 130, and the perimeter of the positive electrode groove portion 130 may include a side 130M in the MD direction, a side 130T in the TD direction, and a curved portion 130R. The curved portion 130R may be an arc of a circle, and the planar shape of the positive electrode groove portion 130 may be a quadrant. In the examples depicted in FIGS. 3 and 4, the MD direction side 130M of the positive electrode groove portion 130 may have a length of about 1.0 mm, and the TD direction side 130T of the positive electrode groove portion 130 may have a length of about 1.0 mm. The length of the positive electrode groove portion 130 in the MD direction may decrease in a direction moving away from the first side 110M.

The negative electrode plate 200 of the electrode assembly 30 and 40 according to an exemplary embodiment may include a second composite portion 220 and a negative electrode groove portion 230 formed by cutting at least a part of the second composite portion 220. The perimeter of the negative electrode groove portion 230 may include a side 230M in the MD direction, a side 230T in the TD direction, and a curved portion 230R. The length l4 of the side 230T in the TD direction of the negative electrode groove portion 230 may be greater than the length l3 of the side 230M in the MD direction of the negative electrode groove portion 230. In the example depicted in FIG. 3, the side 230T in the TD direction of the negative electrode groove portion 230 may have a length of about 2.0 mm, and the side 230M in the MD direction may have a length of about 0.42 mm. In FIG. 3, the length l4 of the side 230T in the TD direction of the negative electrode groove portion 230 may be about 4 to 5 times the length l3 of the side 230M in the MD direction of the negative electrode groove portion 230. According to another example, the side 230T in the TD direction of the negative electrode groove portion 230 in FIG. 4 may have a length of about 2.0 mm, and the side 230M in the MD direction may have a length of about 0.3 mm. In FIG. 4, the length l4 of the side 230T in the TD direction of the negative electrode groove portion 230 may be about 6 to 7 times the length l2 of the side 230M in the MD direction of the negative electrode groove portion 230. The curved portion 230R of the negative electrode groove portion 230 may correspond to an arc of a circle. According to the example depicted in FIG. 3, the center of a circle having a curved portion 230R as an arc may be located on the electrode assembly 30, and the curved portion 230R may be convex upward along the TD direction. According to the example depicted in FIG. 4, the center of the circle having the curved portion 230R as an arc may be located outside the electrode assembly 40, and in this case, the curved portion 230R may be convex downward along the TD direction. The length of the negative electrode groove portion 230 in the MD direction may decrease in a direction moving away from the third side 220M.

In an electrode assembly 30 or 40 according to an exemplary embodiment, the second composite portion 220 of the negative electrode plate 200 may cover the exposed surface of the first composite portion 120 of the positive electrode plate 100. The MD direction side 230M of the negative electrode groove portion 230 may be less than half of the difference between the length of the negative electrode plate 200 and the length of the positive electrode plate 100 along the MD direction. However, embodiments of the present disclosure are not limited to this example. If the second composite portion 220 covers the first composite portion 120, the MD direction side 230M of the negative electrode groove portion 230 may be equal to or greater than half of the difference between the length of the negative electrode plate 200 and the length of the positive electrode plate 100 along the MD direction.

At least one of the length of the positive electrode groove portion 130 along the MD direction or the length of the positive electrode groove portion 130 along the TD direction may be equal to or greater than the minimum detectable length for an inspection device that detects whether the positive electrode plate 100 is defective. In addition, at least one of the length of the negative electrode groove portion 230 along the MD direction and the length of the negative electrode groove portion 230 along the TD direction may be equal to or greater than the minimum detectable length for an inspection device that detects whether or not the negative electrode plate 200 is defective. The inspection device for detecting whether the positive electrode plate 100 is defective may be the same as or different from the inspection device for detecting whether the negative electrode plate 200 is defective. In particular examples, in order for the inspection device(s) to be detect defects in the plates 100 and 200, the groove portions may have a size of at least 1.0 mm in length along the MD direction and at least 1.0 mm in length along the TD direction. Alternatively, the length along the MD direction of the groove portions and the length along the TD direction of the groove portions may have a size of 2.0 mm or more. The length of the side 130M in the MD direction and the length of the side 130T in the TD direction of the positive electrode groove portion 130 are each about 1.0 mm, which may be detected by an inspection device. Among the MD direction side 230M and the TD direction side 230T of the negative electrode groove portion 230, the TD direction side 230T may be about 2.0 mm, which may be detected by an inspection device.

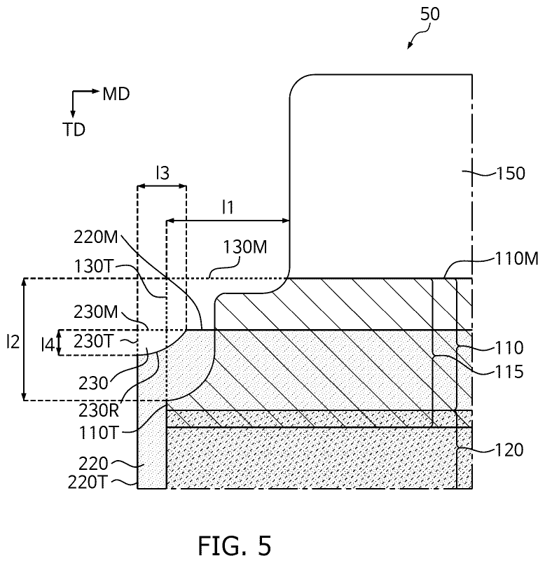

FIG. 5 is a plan view showing an enlarged view of an area around one vertex of an electrode assembly according to an exemplary embodiment. FIG. 5 illustrates an electrode assembly 50 in which the separator 300 is not illustrated, but the separator 300 may be disposed between the positive electrode plate 100 and the negative electrode plate 200.

Referring to FIG. 5, the positive electrode plate 100 of the electrode assembly 50 according to an exemplary embodiment may include a non-coated portion 110, a first composite portion 120, and a positive electrode groove portion 130. An insulating layer may be disposed on the non-coated portion 110 to form an insulating portion 115. The insulating portion 115 and the first composite portion 120 may partially overlap. At least a part of the insulating portion 115 may be cut to form a positive electrode groove portion 130, and the perimeter of the positive electrode groove portion 130 may include a side 130M in the MD direction and a side 130T in the TD direction. The cut side surface of the positive electrode groove portion 130 may include both straight and curved lines. The cut side surface of the positive electrode groove portion 130 may have a constant or decreasing length along the MD direction in a direction moving away from the first side 110M. For example, if the cut side surface of the positive electrode groove portion 130 includes a straight line parallel to the TD direction, the length in the MD direction may be constant. The curve of the cut side surface of the positive electrode groove portion 130 may be, for example, an arc of a circle, but the present disclosure is not limited to this example. For example, the MD direction side 130M of the positive electrode groove portion 130 may have a length of about 4.0 mm, and the TD direction side 130T of the positive electrode groove portion 130 may have a length of about 4.0 mm.

The negative electrode plate 200 of the electrode assembly 50 according to an exemplary embodiment may include a second composite portion 220, and a negative electrode groove portion 230 formed by cutting at least a part of the second composite portion 220. The perimeter of the negative electrode groove portion 230 may include a side 230M in the MD direction, a side 230T in the TD direction, and a curved portion 230R. The length l4 of the side 230T in the TD direction of the negative electrode groove portion 230 may be less than the length l3 of the side 230M in the MD direction of the negative electrode groove portion 230. For example, the side 230T in the TD direction of the negative electrode groove portion 230 may have a length of about 0.8 mm, and the side 230M in the MD direction may have a length of about 2.0 mm. The length l4 of the side 230T in the TD direction of the negative electrode groove portion 230 may be approximately 0.4 times the length l3 of the side 230M in the MD direction of the negative electrode groove portion 230. The curved portion 230R of the negative electrode groove portion 230 may correspond to an arc of a circle. The curved portion 230R of the negative electrode groove portion 230 may be convex downward along the TD direction. The length of the negative electrode groove portion 230 in the MD direction may decrease in a direction moving away from the third side 220M.

The MD direction side 230M of the negative electrode groove portion 230 may be less than the difference between the length of the negative electrode plate 200 and the length of the positive electrode plate 100 along the MD direction. Even in such a case, in the electrode assembly 50 according to the exemplary embodiment, the second composite portion 220 of the negative electrode plate 200 may cover the exposed surface of the first composite portion 120 of the positive electrode plate 100.

At least one of the length of the positive electrode groove portion 130 along the MD direction and the length of the positive electrode groove portion 130 along the TD direction may be longer than the minimum detectable length of for inspection device that detects whether the positive electrode plate 100 is defective. In addition, at least one of the length of the negative electrode groove portion 230 along the MD direction and the length of the negative electrode groove portion 230 along the TD direction may be longer than the minimum detectable length of 1 for inspection device that detects whether or not the negative electrode plate 200 is defective. The inspection device for detecting whether the positive electrode plate 100 is defective may be the same as or different from the inspection device for detecting whether the negative electrode plate 200 is defective. For example, in order for the inspection device to be able to detect defects in the plates 100 and 200, the groove portion may have a size of at least 1.0 mm in length along the MD direction and at least 1.0 mm in length along the TD direction. Alternatively, the length along the MD direction of the groove portion and the length along the TD direction of the groove portion may have a size of 2.0 mm or more. The length of the side 130M in the MD direction and the length of the side 130T in the TD direction of the positive electrode groove portion 130 are each about 4.0 mm, which may be detected by an inspection device. Among the MD direction side 230M or TD direction side 230T of the negative electrode groove portion 230, the length of the MD direction side 230M is about 2.0 mm, which may be detected by an inspection device.

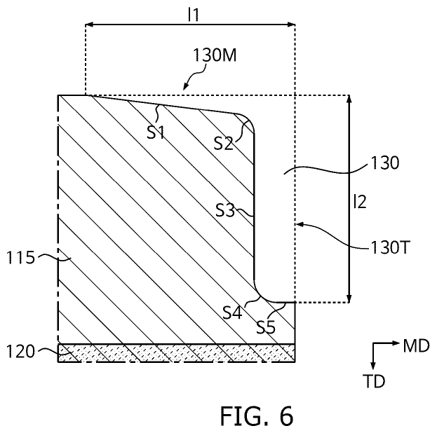

FIG. 6 is a plan view showing an enlarged view of an area around one vertex of a positive electrode plate included in an electrode assembly according to an exemplary embodiment.

The positive electrode groove portion 130 of the positive electrode plate 100 of the electrode assembly according to an exemplary embodiment may have various shapes. Referring to FIG. 6, the positive electrode plate 100 may include a non-coated portion, a first composite portion 120, and a positive electrode groove portion 130. An insulating layer may be disposed on the non-coated portion 110 to form an insulating portion 115. The insulating portion 115 and the first composite portion 120 may partially overlap. At least a part of the insulating portion 115 may be cut to form a positive electrode groove portion 130, and the perimeter of the positive electrode groove portion 130 may include a side 130M in the MD direction and a side 130T in the TD direction. The cut side surface of the positive electrode groove portion 130 may include both straight and curved lines. For example, the cut side surface of the positive electrode groove portion 130 may include a straight line S1 intersecting the TD direction from the first side 110M, an arc S2 of a circle having a first radius, a straight line S3 parallel to the TD direction, an arc S4 of a circle having a second radius, and a straight line S5 perpendicular to the TD direction. The cut side surface of the positive electrode groove portion 130 may have a constant or decreasing length in the MD direction in a direction moving away from the first side 110M. In the straight line section S3 parallel to the TD direction, the length along the MD direction may be constant, and in the remaining sections S1, S2, S4 and S5, the length along the MD direction may decrease. In a particular example, the side 130M in the MD direction of the positive electrode groove portion 130 may have a length of about 1.0 mm, and the side 130T in the TD direction of the positive electrode groove portion 130 may have a length of about 1.0 mm.

At least one of the length of the positive electrode groove portion 130 along the MD direction and the length of the positive electrode groove portion 130 along the TD direction may be equal to or greater than the minimum detectable length for an inspection device that detects whether the positive electrode plate 100 is defective. In order for the inspection device to be detect defects in the positive electrode plate 100, the groove portion may have a size of at least 1.0 mm in length along the MD direction and at least 1.0 mm in length along the TD direction. Thus, the length of the side 130M in the MD direction and the length of the side 130T in the TD direction of the positive electrode groove portion 130 are each about 1.0 mm, which may be detected by an inspection device.

In addition, the shape and/or size of the planar shape of the positive electrode groove portion 130 or the negative electrode groove portion 230 may be selected as needed. For example, the size of the positive electrode groove portion 130 or the negative electrode groove portion 230 may be selected to be equal to or greater than a size having a minimum detectable length of for inspection device that detects a defect in the positive electrode plate 100 or the negative electrode plate 200. The size and/or shape of the positive electrode groove portion 130 or the negative electrode groove portion 230 may be selected such that the second composite portion 220 may cover the exposed surface of the first composite portion 120.

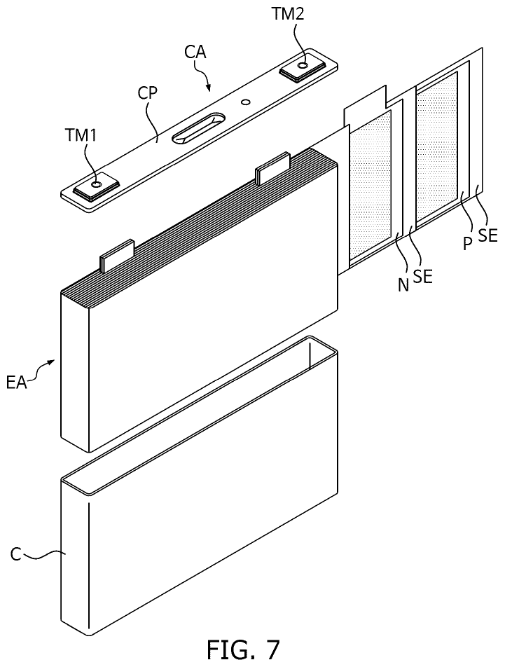

FIG. 7 is an exploded perspective view of a secondary battery according to an exemplary embodiment.

Referring to FIG. 7, a secondary battery according to an exemplary embodiment may include an electrode assembly EA, a case C accommodating the electrode assembly EA, and a cap assembly CA sealing an opening of the case C.

The electrode assembly EA may be in the form of a first electrode P, a separator SE, and a second electrode N sequentially stacked. Here, the first electrode P may be a positive electrode and the second electrode N may be a negative electrode, or vice versa. The electrode assembly EA of FIG. 7 may correspond to one of the electrode assemblies 10, 20, 30, 40 and 50 described in FIGS. 1a to 5. Additionally, the first electrode P, the second electrode N, and the separator SE may correspond to the positive electrode plate 100, the negative electrode plate 200, and the separator 300, respectively. However, the present disclosure is not limited to this example, and the electrode assembly EA may be formed by winding a first electrode P, a separator SE, and a second electrode N in a jellyroll shape.

The case C may have an opening on one side and a hollow space to accommodate an electrode assembly EA therein. The case C may be formed of a conductive metal such as aluminum, an aluminum alloy, or nickel-plated steel. Alternatively, the case C may be formed of stainless steel SUS. But the present disclosure is not limited to these examples.

The cap assembly CA may be joined to the opening of the case C after the electrode assembly EA is accommodated in the case C, thereby sealing the case C. Additionally, the first electrode P and the second electrode N of the electrode assembly EA may be electrically connected to the terminal plates TM1 and TM2 provided in the cap assembly CA, respectively.

The secondary battery according to the exemplary embodiment of FIG. 7 may be a lithium ion secondary battery in the form of a prismatic battery. However, embodiments of the present disclosure not limited to this example, and embodiments include other types of batteries such as pouch-type batteries or cylindrical batteries.

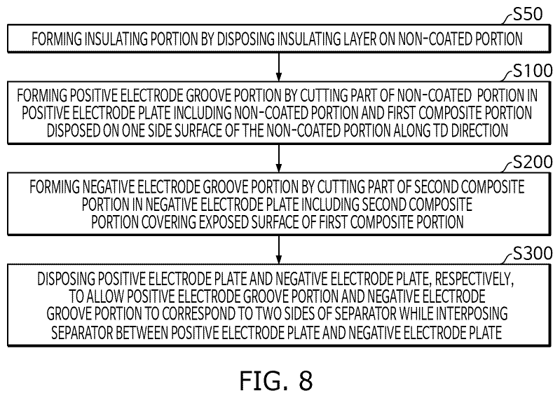

FIG. 8 is a flowchart of a method of manufacturing an electrode assembly according to an exemplary embodiment.

Referring to FIG. 8, a method of manufacturing an electrode assembly according to an exemplary embodiment may include a step S100 of forming a positive electrode groove portion by cutting a part of a non-coated portion in a positive electrode plate including a first composite portion and the non-coated portion disposed on one side surface of the first composite portion along a TD direction, a step S200 of forming a negative electrode groove portion by cutting a part of the second composite portion in a positive electrode plate including a second composite portion covering an exposed surface of the first composite portion, and a step S300 of disposing the positive electrode plate and the negative electrode plate, respectively, so that the positive electrode groove portion and the negative electrode groove portion correspond to two sides of the separator with the separator positioned between the positive electrode plate and the negative electrode plate. At least one of the length of the positive electrode groove portion along the MD direction and the length of the positive electrode groove portion along the TD direction may be equal to or greater than the minimum detectable length of for inspection device that detects whether the positive electrode plate is defective. Additionally, at least one of the length of the negative electrode groove portion along the MD direction and the length of the negative electrode groove portion along the TD direction may be equal to or greater than the minimum detectable length of an inspection device that detects whether or not the positive electrode plate is defective.

A method of manufacturing an electrode assembly according to an exemplary embodiment may include a step S100 of forming a positive electrode groove portion by cutting a portion of the non-coated portion from a positive electrode plate including a first composite portion and a non-coated portion disposed on one side surface of the first composite portion along the TD direction. The positive electrode plate may be a positive electrode plate having a positive electrode active material layer disposed on a substrate. The substrate portion where the active material layer is disposed may correspond to the first composite portion, and the substrate portion where the active material layer is not disposed may correspond to the non-coated portion. The active material layer may be coated and disposed on a substrate. One cut region of the non-coated portion may correspond to the vertex of the non-coated portion that does not meet the first composite portion, or a region around the vertex.

A method for manufacturing of electrode assembly according to an exemplary embodiment may further include a step S50 of forming an insulating portion by disposing an insulating layer on a non-coated portion before the step S100 of forming a positive electrode groove portion. The insulating portion may be formed by coating an insulating layer on the non-coated portion. When the electrode assembly includes an insulating portion, the positive electrode groove portion may be formed by cutting at least a part of the insulating portion. The non-coated portion and the insulating layer disposed on the non-coated portion may be cut together. Because the electrode assembly according to the exemplary embodiment includes an insulating portion, defects due to short circuits between the positive and negative electrode plates may be reduced.

According to an embodiment, the step S100 of forming the positive electrode groove portion may be performed by notching using a laser. That is, the non-coated portion or the insulating portion of the positive electrode may be notched by a laser. Because the positive electrode groove portion is formed by cutting at least a part of the non-coated portion of the positive electrode plate and/or a part of the insulating portion, the positive electrode groove portion may be formed by notching using a laser in addition to, or as an alternative to, notching using a mold. Thus, if the positive electrode groove portion 130 is formed by notching using a laser, a positive electrode plate may be provided without problems associated with using a mold, such as mold management and foreign matter problems.

According to an embodiment, in the step of forming the positive electrode groove portion S100, the positive electrode groove portion may be formed in various sizes or shapes. Because this has been described with reference to FIGS. 1A to 6 above, a further description is omitted here.

In the step of forming a positive electrode groove portion S100, the positive electrode groove portion may be formed such that at least one of the length of the positive electrode groove portion along the MD direction and the length of the positive electrode groove portion along the TD direction is equal to or greater than the minimum detectable length for an inspection device that detects whether or not the positive electrode plate is defective. For example, in order for a particular inspection device to detect a defect, the positive electrode groove portion may have a size of at least 1.0 mm in length along the MD direction and at least 1.0 mm in length along the TD direction. Alternatively, the length along the MD direction of the positive electrode groove portion and the length along the TD direction of the positive electrode groove portion may have a size of 2.0 mm or more.

A method of manufacturing an electrode assembly according to an exemplary embodiment may include a step S200 of forming a negative electrode groove portion by cutting a part of a second composite portion from a negative electrode plate including a second composite portion covering an exposed surface of a first composite portion. The negative electrode plate may be a plate having a negative active material layer disposed on a substrate. The substrate portion where the active material layer is disposed may correspond to the second composite portion, and the substrate portion where the active material layer is not disposed may correspond to the non-coated portion. The active material layer may be coated and disposed on a substrate. One cut region of the second composite portion may correspond to the vertex of the second composite portion and a region around the vertex. In an embodiment, the step of forming the negative electrode groove portion may be performed using a mold.

According to one embodiment, in the step of forming a negative electrode groove portion S200, the negative electrode groove portion may be formed in various sizes or shapes. A negative electrode groove portion may be formed so that the second composite portion covers the exposed surface of the first composite portion. Alternatively, the negative electrode groove portion may be formed so that the negative electrode groove portion is not disposed on the first composite portion. Because this has been described with reference to FIGS. 1A to 6 above, a further description here will be omitted.

In the step of forming a negative electrode groove portion S200, the negative electrode groove portion may be formed such that at least one of the length of the negative electrode groove portion along the MD direction and the length of the negative electrode groove portion along the TD direction is equal to or greater than the minimum detectable length for an inspection device that detects whether or not the negative electrode plate is defective. In a particular example, in order for the inspection device to detect a defect, the negative electrode groove portion may have a size of 1.0 mm or more in the MD direction and 1.0 mm or more in the TD direction. Alternatively, the length along the MD direction of the negative electrode groove portion and the length along the TD direction of the negative electrode groove portion may have a size of 2.0 mm or more.

After the step of forming the positive electrode groove portion S100, the step of forming the negative electrode groove portion S200 may be performed. However, the present disclosure is not limited to this example, and the step of forming the positive electrode groove portion S100 may be performed after the step of forming the negative electrode groove portion S200, or the steps may be performed simultaneously.

A method of manufacturing an electrode assembly according to an exemplary embodiment may include a step S300 of positioning a positive electrode plate and a negative electrode plate to allow a positive electrode groove portion and a negative electrode groove portion to correspond to two sides of a separator in a state where the separator is interposed between the positive electrode plate and the negative electrode plate. As the positive electrode groove portion corresponds to the negative electrode groove portion, one positive electrode groove portion and one negative electrode groove portion are disposed near one vertex of the separator. A separator may electrically insulate the positive and negative electrode plates while allowing the movement of specific ions between the positive electrode plate and the negative electrode plate.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

1. An electrode assembly comprising:
a positive electrode plate including a non-coated portion having a first side in a first direction and a second side in a second direction that is transverse to the first direction, a first composite portion adjacent to the non-coated portion, and a positive electrode groove portion formed at a vertex where the first side and the second side meet;
a negative electrode plate including a second composite portion having a third side in the first direction and a fourth side in the second direction and covering a surface of the first composite portion, and a negative electrode groove portion formed at a vertex where the third side and the fourth side meet; and
a separator positioned between the positive electrode plate and the negative electrode plate.

2. The electrode assembly as claimed in claim 1, wherein the positive electrode plate includes an insulating portion including an insulating layer that partially overlaps the first composite portion and covers at least a part of a surface of the non-coated portion, and
wherein a length of the insulating portion along the second direction is 0.5 mm to 10 mm.

3. The electrode assembly as claimed in claim 1, wherein the negative electrode groove portion has a planar shape with a length in the first direction that decreases in a direction moving away from the third side.

4. The electrode assembly as claimed in claim 1, wherein a length of the negative electrode groove portion along the first direction is 0.1 mm to 5 mm, and
wherein a length of the negative electrode groove portion along the second direction is 0.1 mm to 5 mm.

5. The electrode assembly as claimed in claim 4, wherein the length of the negative electrode groove portion along the second direction is 0.1 to 20 times the length of the negative electrode groove portion along the first direction.

6. The electrode assembly as claimed in claim 1, wherein a side surface of the negative electrode groove portion includes a curved portion.

7. The electrode assembly as claimed in claim 6, wherein at least a part of the curved portion of the negative electrode groove portion has a curved shape that is convex downward or convex upward along the second direction.

8. The electrode assembly as claimed in claim 6, wherein the curved portion of the negative electrode groove portion includes an arc-shaped section.

9. The electrode assembly as claimed in claim 1, wherein the negative electrode plate covers at least a part of the non-coated portion of the positive electrode plate.

10. The electrode assembly as claimed in claim 1, wherein a length of the second composite portion along the second direction is greater than a length of the first composite portion along the second direction, and
wherein a length of the second composite portion along the first direction is greater than a length of the first composite portion along the first direction.

11. The electrode assembly as claimed in claim 1, wherein an area of a plane of the second composite portion is greater than an area of a plane of the first composite portion.

12. The electrode assembly as claimed in claim 1, wherein the positive electrode plate further includes a positive electrode tab portion extending from a surface of the non-coated portion, and
wherein the negative electrode plate further includes a negative electrode tab portion extending from a surface of the second composite portion.

13. The electrode assembly as claimed in claim 1, wherein a length of the positive electrode groove portion along the first direction is 0.1 mm to 5 mm, and
wherein a length of the positive electrode groove portion along the second direction is 0.1 mm to 5 mm.

14. The electrode assembly as claimed in claim 13, wherein a side surface of the positive electrode groove portion includes a curved portion, and
wherein the positive electrode groove portion has a planar shape with a length in the first direction that decreases in a direction moving away from the first side.

15. An electrode assembly comprising:
a positive electrode plate including a non-coated portion having a first side in a first direction and a second side in a second direction that is transverse to the first direction, a first composite portion disposed adjacent to the non-coated portion along the second direction, and a positive electrode groove portion formed at a vertex of the non-coated portion;
a negative electrode plate including a second composite portion covering a surface of the first composite portion, and a negative electrode groove portion formed by cutting at least one vertex of the second composite portion; and
a separator positioned between the positive electrode plate and the negative electrode plate,
wherein at least one of a length of the positive electrode groove portion along the second direction and a length of the positive electrode groove portion along a first direction that is perpendicular to the second direction is equal to or greater than a minimum detectable length for an inspection device that is configured to detect whether the positive electrode plate is defective, and
wherein at least one of a length of the negative electrode groove portion along the TD direction and a length of the negative electrode groove portion along the MD direction is equal to or greater than the minimum detectable length for the inspection device, which is configured to detect whether the negative electrode plate is defective.

16. The electrode assembly as claimed in claim 15, wherein the positive electrode plate includes an insulating portion including an insulating layer that partially overlaps the first composite portion and covers at least a part of a surface of the non-coated portion, and
wherein a length of the insulating portion along the second direction is 0.5 mm to 10 mm.

17. The electrode assembly as claimed in claim 15, wherein a minimum detectable length for the inspection device is 0.1 mm to 2 mm.

18. The electrode assembly as claimed in claim 16, wherein a length of the negative electrode groove along the first direction is less than or equal to 50% of a difference between a length of the negative electrode plate and a length of the positive electrode plate in the first direction.

19. A method of manufacturing an electrode assembly, the method comprising:
forming a positive electrode groove portion by cutting a part of a non-coated portion of a positive electrode plate that includes a first composite portion adjacent to a side surface of the non-coated portion along a second direction;
forming a negative electrode groove portion by cutting a part of a second composite portion of a negative electrode plate that includes a second composite portion that covers a surface of the first composite portion; and
positioning the positive electrode plate and the negative electrode plate such that the positive electrode groove portion and the negative electrode groove portion to correspond to two sides of a separator with the separator positioned between the positive electrode plate and the negative electrode plate,
wherein at least one of a length of the positive electrode groove portion along a first direction that is perpendicular to the second direction and a length of the positive electrode groove portion along the second direction is equal to or greater than a minimum detectable length for an inspection device that detects whether the positive electrode plate is defective, and
wherein at least one of a length of the negative electrode groove portion along the first direction and a length of the negative electrode groove portion along the second direction is equal to or greater than a minimum detectable length for an inspection device that detects whether the negative electrode plate is defective.

20. The method as claimed in claim 19, further comprising:
forming an insulating portion by disposing an insulating layer on the non-coated portion before the forming the positive electrode groove portion,
wherein the forming of the positive electrode groove portion is performed by laser notching.
